(19) United States
(12) Patent Application Publication
(10) Pub. No.: US 2008/0149044 A1
(43) Pub. Date: Jun. 26, 2008

(54) SHOCK ABSORBING DOG LEASH ATTACHMENT AND DOG LEAD ATTACHMENT

(76) Inventor: Peter Andrew Reaves, Durham, NC (US)

Correspondence Address: Peter Andrew Reaves, 1802 Hillcrest Drive, Durham, NC, 27705-3349, US

(21) Appl. No.: 11/615,970

(22) Filed: Dec. 23, 2006

(51) Int. Cl. A01K 27/00

(52) U.S. Cl. 119/798

(57) ABSTRACT

A shock absorbing dog leash attachment and dog lead attachment that includes a length of elastic material which is looped on each end. The loops are closed by binding the length of material to itself. A reusable fastener which can be connected to a dog's collar is attached to one of the loops. The other loop can be connected to a leash or fixed lead. In this configuration, the assembly absorbs the jerks or tugs caused by the dog's attempts to move bodily beyond the range of the leash or lead.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to attachments for dog leashes and dog leads, specifically shock absorbing dog leash attachments and dog lead attachments.

2. Background of the Invention

Owners of domesticated dogs commonly take their dogs for walks outside the home. Said owners generally restrain their dogs during such walks with static, non-flexible dog leashes. Said leashes are available commercially in many forms and aesthetic styles. For example, some dog owners prefer one-piece static-line leashes, which are available commercially in a variety of fixed lengths, while others prefer retractable reel-type static-line leashes which extend to lengths over 20 feet.

Owners of domesticated dogs also commonly attach their dogs to static lines outdoors on the owners' property. Said static lines are commonly attached to a fixed object, such as a stake or a post on one end, and the dog on the other end. These lines are commonly called “leads” and will be referred to as “leads” for the purposes of this patent application.

Dogs are connected to leashes or leads most commonly by latching one end of the leash or lead to the dog's neck-collar. Such latching is achieved by an interface of hardware; commonly a hook or clip of some kind on the leash or lead attached to a ring on the dog's neck-collar.

A problem arises when a dog which is attached to a leash or a lead attempts to propel itself bodily to a location farther away from the leash holder than the length of the leash, or, in the case of a fixed lead, a location farther away from the fixed object to which the lead is attached than the length of that lead. Such excited and sometimes forceful movements are often unexpected by the human holder of the moving dog's leash and are common behavior among most dogs.

For example, a dog may be drawn to a squirrel or some attractive smell and bolt toward said squirrel or smell. In this example, when said fast-moving dog reaches the range of the human-held leash or fixed lead to which the dog is attached, a violent physical jolt is transmitted through the taut leash or lead as the dog's movement is suddenly halted. Said violent physical jolt is absorbed by the dog's neck and the leash-holder's arm/shoulder in the case of a leashed dog, or is absorbed solely by the dog's neck in the case of a dog connected to a fixed lead. Said violent reaction can lead to discomfort or injury for the leash holder and/or the dog connected to either a leash or lead.

The above-described problem can be mitigated by introducing an element of flexibility to dog leashes and leads. Several inventions for flexible leash/lead elements have been proposed in the past, but all have had significant drawbacks. The following five paragraphs discuss those inventions. The patents and patent application noted below are attached to this application and cited fully in the attached INFORMATION DISCLOSURE STATEMENT BY APPLICANT.

U.S. Pat. Nos. 5,873,328, D408,103, D362,519, 6,990,929, 5,146,876, 6,053,129, 6,851,393 and 6,971,334 show shock absorbing leashes. All of these inventions are entire leash assemblies. None of these inventions can be used to absorb shock transmitted through a lead as the present invention can, because they are not designed to attach to a lead. Another distinction, between the referenced inventions and the present invention is that the referenced inventions replace a static leash entirely while the present invention does not. This is an important distinction because dog owners commonly appreciate certain functional and/or aesthetic aspects of the leashes they have already purchased.

U.S. Pat. Nos. 4,488,511, 7,032,529, 5,482,258 and 4,681,303 show shock absorbers which could be affixed between a leash or lead and a dog's collar. These inventions are more complex and appear heavier than the present invention. The distinction regarding the complexity of a shock absorbing leash attachment or lead attachment is important because a complex device hanging from a dog's collar is more likely to become damaged due to the recklessness with which some dogs maneuver themselves and the dirt and moisture dogs encounter frequently during walks outdoors than the present invention. Further, a complex device is generally more costly to manufacture and require more skill to use and maintain than the present invention. The distinction as to the weight of a shock absorbing leash attachment or lead attachment is important because a weighty device hanging from a dog's collar is more likely than the apparently lighter present invention to pull the leash down to the ground when the leash is not fully taut, at which point the dog would be more likely to entangle its legs in the leash. A weighty device close to the dog's head is also more likely than the apparently lighter present invention to lead to injury of the dog should the device strike the dog.

U.S. Pat. No. 4,667,625 shows a dog run apparatus with shock absorbing capability. The distinction between this invention and the present invention is that the present invention can be used in conjunction with a leash or a lead, while the dog run apparatus referenced cannot be used in conjunction with a leash.

U.S. Pat. No. 6,564,754 shows an elastic harness which is designed to reduce the shock absorbed by the dog when the dog is restrained. The main distinction between this invention and the present invention is that the referenced invention provides a means of harnessing a dog, while the present invention does not. Further, the referenced invention requires various straps and loops of the invention to be installed on the dog each time the dog is to be walked, while the present invention need only be clipped to a dog's leash in one action. This distinction regarding simplicity of use is important.

WIPO Patent Application WO9531897 shows a shock absorbing leash attachment. The critical distinction between this invention and the present invention is the means by which the assemblies are held together. The “end members” referenced in the claim and the specification and shown on the drawing pages for WO9531897 and attached to the terminals of the shock cord are apparently made of metal or some other high-density material because of their size in relation to the forces they would be required to sustain. The present invention does not have what are apparently metal or high-density material end members that are distinct from the shock cord, but rather loops of the shock cord which are closed by binding the looped ends to the main length of the shock cord. There are four reasons why these distinctions in assemblies are important. First, this distinction is important because the shock cord of the referenced invention does not appear to be able to withstand the same amount of pulling force as the present invention for the simple reason that there are more joints from end to end and because the configuration is apparently less strong than that of the present invention. Second, the distinction is important because the referenced invention has bare metal or other high-density material exposed on a section of the invention most distant from the dog, the section of a leash attachment that will likely strike the dog with the greatest speed when whipping about as a result of the dog's movements, while the present invention does not have any exposed metal or other high-density material on the section of the invention most distant from the dog. Such exposed metal or other high-density material moving at high speed would be more likely to injure a dog than a flexible loop of shock cord. Third, the parts and labor required for the “end members” and internal “non-extensible line such as a nylon or metal wire” with associated internal metal ball components of the referenced invention could make the device substantially more expensive that the present invention, which is comprised of only four different parts. Fourth, because there are more component parts of the referenced invention than the present invention, the referenced invention is more complex and thereby possibly more prone to problems in manufacture and use than the present invention.

For all of the reasons stated above, the present invention is substantially distinct from all of the above-mentioned prior arts.

### BRIEF SUMMARY OF THE INVENTION

The principal and secondary objects of the invention are to provide a shock absorbing dog leash attachment and dog lead attachment that is strong enough to sustain heavy loads and withstand repeated rapid lengthening and shortening without damage or deformity, easy enough to install and use with a minimum of effort, be of construction simple enough to remain effective in dirty and/or wet environments, light enough to not pose a hazard should the invention strike the dog to which the invention is attached, and economical enough to be commercially viable. Further, the invention can be built for any size and weight of dog without further design by adjusting the invention's proportions.

These and other valuable objects are achieved by a length of shock cord with a loop on each end, a bolt-snap fastener threaded through the cord comprising one of said loops, the loop terminals securely joined to the main shock cord length, and those joints covered by a malleable protective casing.

### BRIEF DESCRIPTION OF THE SEVERAL VIEWS OF THE DRAWING

FIG. 1 is the invention positioned lengthwise vertically with the bolt-snap fastener end at the top of the page, with the loops of the shock cord obscured visually by the main shock cord length, and with the protective casing covering the area where the loop terminal is joined to the main shock cord length.

FIG. 2 is the invention positioned lengthwise vertically turned 90 degrees on its vertical axis from the position shown in FIG. 1, with the bolt-snap fastener end at the top of the page, with the loops of the shock cord visible, and with the protective casing covering the area where the loop terminal is joined to the main shock cord length.

FIG. 3 is the invention positioned lengthwise vertically turned 90 degrees on its vertical axis from the position shown in FIG. 1, with the bolt-snap fastener end at the top of the page, with the loops of the shock cord visible, and the protective casing opened on the upper joint between the looped end of the shock cord and the main length of the shock cord, revealing the binding hardware of said joint in three stages of closure.

### DESCRIPTION OF THE PREFERRED EMBODIMENT OF THE INVENTION

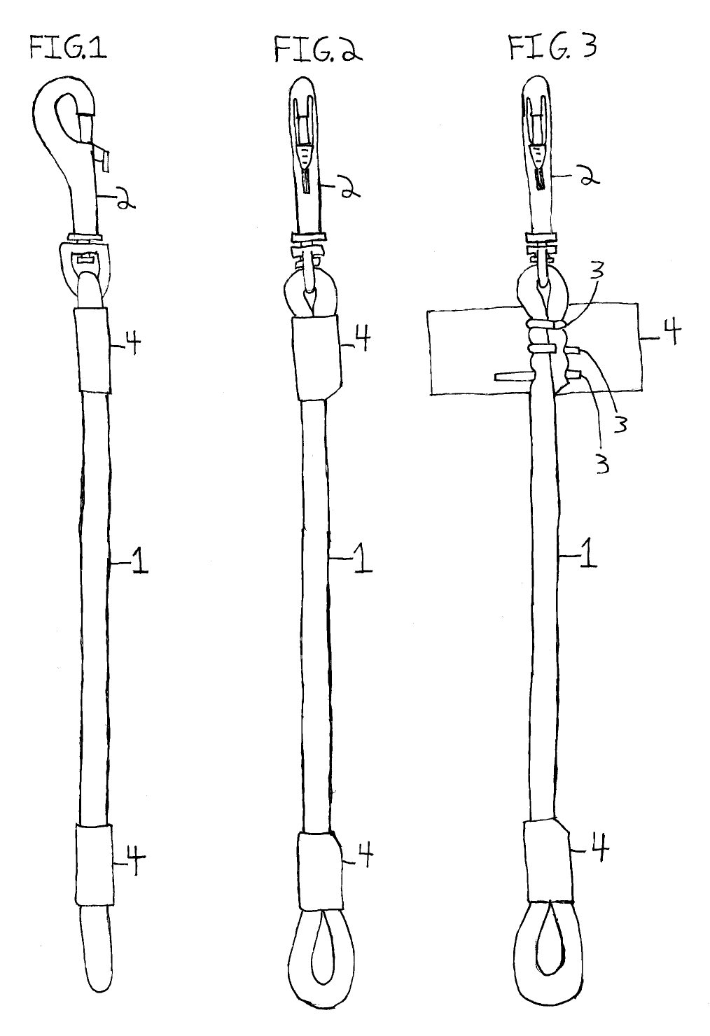

Referring now to the drawing, there is shown in FIG. 1 the entire invention with the bolt-snap fastener end at the top of the page. The shock cord 1 is comprised of an elastic core and a woven, flexible protective nylon covering, such as the nylon covered shock-cord of the type that expands approximately 100% of its unstretched length, and is available from Reef Scuba Accessories, Inc. of Chesapeake, Va. The bolt-snap fastener 2 has a spring loaded clip on one end and a closed loop on the other as evidenced by the profile view of the bolt-snap afforded by FIG. 1, and is available from Universal Mercantile eXchange, Inc., of Walnut, Calif. The bolt-snap includes a free-swiveling joint such that one end of the bolt-snap can turn freely around its vertical axis to minimize tangling of the attached leash or lead. The binding hardware 3 is strips of metal which are clamped into o-shaped bindings by a crimping tool designed for creating high-strength bindings for shock cords. Both the clamps and the crimping tool are available from Reef Scuba Accessories, Inc., of Chesapeake, Va. Said clamps are shown in three stages of closure for illustrative purposes in FIG. 3. When the invention is assembled, the clamps are in the fully closed position as illustrated by the topmost clamp shown in FIG. 3. FIG. 1, FIG. 2, and FIG. 3 each show the protective casing 4 for the binding hardware. Said casing is ideally made of malleable and durable self-fusing tape such as that available through Henkel Consumer Adhesive, Inc., of Avon, Ohio, but could be any form-fitting lightweight covering which protects the metal clamps from damage and protects the dog to which the invention is attached from being struck directly by the metal clamps. The invention is comprised of only four different parts, the combination of which are cheap enough to make the invention commercially viable as a shock absorbing dog leash attachment and dog lead attachment.

The invention is assembled by cutting a length of the shock cord, threading one end of the shock cord through the bolt-snap fastener, then doubling back the portion of the cord that was threaded through the bolt-snap 180-degrees so that said cord portion is against the main length of cord to form a loop. At the other end of the cord, a portion of the cord is also doubled back on itself 180-degrees to form a loop. The ends of the cord, which have been doubled back against the main cord length to form a loop, are then bound to said main cord length with the clamps. The clamps and the doubled and bound sections of the cord are then covered with the protective casing. The labor required to assemble the invention is minimal.

The invention in its preferred embodiment can be built in different sizes to accommodate different sized dogs but should maintain roughly the same proportions as shown in the drawing. For example, the length and diameter of the shock cord element depends upon the size and weight of the dog for which the invention is used. For example, a dog of 40 pounds and medium height for that weight would use a version of the invention with ⅜^{th} inch diameter shock cord having a minimum breaking load rating of 225 pounds and a total invention length of approximately 10 inches. The ⅜^{th} inch diameter cord would provide sufficient strength to withstand the forces transmitted through the leash when said dog is stopped by the restraint imposed by a leash or lead. Also, this thickness of cord would afford sufficient resistance to expansion in order to provide the shock-absorption needed to reduce the likelihood of pain or injury caused by a sharp, powerful jerk to the dog and the leash holder in the case of a leash, or the dog alone in the case of a lead. Further, the length of the invention should be short enough to prevent the dog from becoming entangled in the attachment, but also long enough to provide enough shock-absorbing stretch length. Finally, the size and strength of the invention's bolt snap should vary according to the size of dog for which the invention is constructed. All of the components which comprise the invention are available in a variety of forms, sizes and strengths. This variety is great enough for the invention to be built to accommodate all sizes of dogs. Thus, the scope of the invention should be determined by the appended claims and their legal equivalents, rather than by the examples given.

The invention in its preferred embodiment is used by connecting the bolt snap on the one end of the invention to the dog's collar, and connecting the bare loop on the opposite end of the invention to a dog leash or a fixed dog lead. The invention will then mitigate the sometimes strong jerks or pulls of the dog that would otherwise be absorbed by the dog or the leash holder. Once attached to the leash or lead, the invention can be left attached thereto for future use without any further action. Should the invention be whipped around on the pivot-point of the invention's attachment to the dog's collar, the dog is only in danger of being struck by the flexible bare loop end of the shock cord or the malleable protective covering over the binding clamps of the invention.

1. A dog leash attachment and dog lead attachment comprising:
(a) a length of elastic material,
(b) that is looped on each end,
(c) with a reusable fastener attached to one loop, and
(d) with the loops closed by binding the material to itself.
